(19) United States
(12) Patent Application Publication
(10) Pub. No.: US 2026/0338099 A1
(43) Pub. Date: Oct. 29, 2026

(54) MOUNTING BRACKET LIFT EYE FOR AN EXHAUST AFTERTREATMENT ASSEMBLY

(71) Applicant: CUMMINS EMISSION SOLUTIONS INC., Columbus, IN (US)

(72) Inventors: Paul Clark Smith, Edina, MN (US); Prateek RAVINDRA BALIGA, Springfield, IL (US); Andrei Palfi, Brasov (RO); Charles N. Bowen, Ann Arbor, MI (US)

(73) Assignee: CUMMINS EMISSION SOLUTIONS INC., Columbus, IN (US)

(21) Appl. No.: 19/107,384

(22) PCT Filed: Aug. 31, 2022
(86) PCT No.: PCT/RO2022/050008

§ 371 Date: Feb. 27, 2025

(51) Int. Cl. F01N 13/18; F01N 3/10; F01N 3/28; F01N 13/00; F02B 39/00

(52) U.S. Cl. CPC F01N 13/1805; F01N 3/101; F01N 3/2803; F01N 13/008; F01N 13/18; F02B 39/00; F01N 2450/00; F01N 2560/02

(57) ABSTRACT

An exhaust aftertreatment assembly includes a catalyst housing and a shell. The catalyst housing is configured to contain at least one catalyst therein. The shell is coupled to the catalyst housing. The shell includes an end cap fixed to the catalyst housing and a mounting bracket monolithically formed with the end cap. The mounting bracket extends radially away from the end cap. The mounting bracket includes a mounting portion and a lift portion. The mounting portion defines a first mounting opening that is structured to receive a first fastener. The lift portion defines a lift opening that is structured to receive a portion of a lifting arm.

### FIELD

The present disclosure relates generally to an aftertreatment system for an internal combustion engine.

### BACKGROUND

It is desirable to treat exhaust produced by combustion of fuel in an internal combustion engine. An engine system may include an aftertreatment system configured to treat the exhaust. In manufacturing the engine system, the aftertreatment system may be coupled to the engine or a component downstream of the engine, such as a turbocharger.

### SUMMARY

In one embodiment, an exhaust aftertreatment assembly includes a catalyst housing and a shell. The catalyst housing is configured to contain at least one catalyst therein. The shell is coupled to the catalyst housing. The shell includes an end cap fixed to the catalyst housing and a mounting bracket monolithically formed with the end cap. The mounting bracket extends radially away from the end cap. The mounting bracket includes a mounting portion and a lift portion. The mounting portion defines a first mounting opening that is structured to receive a first fastener. The lift portion defines a lift opening that is structured to receive a portion of a lifting arm.

In another embodiment, a gasoline engine system includes an engine, a connecting bracket, and an exhaust aftertreatment system. The connecting bracket is coupled to the engine. The exhaust aftertreatment system is coupled to the connecting bracket. The exhaust aftertreatment system includes a catalyst housing and a shell. The catalyst housing is configured to contain at least one catalyst therein. The shell is coupled to the catalyst housing. The shell includes an end cap fixed to the catalyst housing and a mounting bracket monolithically formed with the end cap. The mounting bracket extends radially away from the end cap. The mounting bracket includes a mounting portion and a lift portion. The mounting portion defines a first mounting opening that is structured to receive a first fastener such that the first fastener couples the shell to the connecting bracket. The lift portion extends away from the mounting portion. The lift portion defines a lift opening structured to receive a portion of a lifting arm.

In another embodiment, a method of assembling an engine system, includes providing an engine. The method also includes providing an exhaust aftertreatment system that includes a catalyst housing and a shell. The catalyst housing is configured to contain at least one catalyst therein. The shell is coupled to the catalyst housing. The shell includes an end cap and a mounting bracket. The end cap is fixed to the catalyst housing. The mounting bracket is monolithically formed with the end cap and extends radially away from the end cap. The mounting bracket includes a mounting portion and a lift portion. The mounting portion defines a first mounting opening structured to receive a first fastener. The lift portion extends away from the mounting portion. The lift portion defines a lift opening. The method also includes engaging, by a portion of a lift arm, the lift opening such that the portion of the lift arm is received by the lift opening. The method also includes lifting the exhaust aftertreatment system, by the portion of the lift arm received by the lift opening. The method also includes coupling the exhaust aftertreatment system to the engine by a connecting bracket structured to receive the first fastener.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a side view of an example engine system;

FIG. 2 is a front perspective view of the engine system of FIG. 1;

FIG. 3 is a top perspective view of the engine system of FIG. 1;

FIG. 4 is an exploded view of an example aftertreatment system and mounting features for the engine system of FIG. 1;

FIG. 5 is a perspective view of an example aftertreatment system for use in the engine system of FIG. 1;

FIG. 6 is a cross-sectional view of the aftertreatment system of FIG. 5;

FIG. 7 is a side perspective view of an example aftertreatment system and an example lift arm;

FIG. 8 is a rear perspective view of the aftertreatment system and lift arm of FIG. 7;

FIG. 9 is a front view of the aftertreatment system of FIG. 5, showing a welding tool;

FIG. 10 is a side view of the aftertreatment system of FIG. 5, showing a welding tool;

FIG. 11 is a cross-sectional view of the aftertreatment system of FIG. 5, showing a welding tool in a first position; and

FIG. 12 is a cross-sectional view of the aftertreatment system of FIG. 5, showing a welding tool in a second position.

It will be recognized that the Figures are schematic representations for the purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and for valve assembly for a mounting bracket lift eye for an exhaust aftertreatment assembly. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

In an engine system, an aftertreatment system may be provided to reduce harmful exhaust gas emissions, such as nitrogen oxides (NOx). The aftertreatment system may be large, heavy, and/or otherwise difficult to position when assembling the engine system. A lift arm, such as a crane (e.g., an overhead crane) or other overhead support or lifting device may be used to position the aftertreatment system relative to the engine such that the aftertreatment system may be coupled to one or more components of the engine system.

Implementations herein are directed to an aftertreatment system for an engine system. The aftertreatment system includes a mounting bracket having a “lift eye” or lift opening for receiving a portion of a lift arm. The mounting bracket may be disposed at a fist radial side of the aftertreatment system such that the lift opening is axially aligned with a center of gravity of the aftertreatment system. The aftertreatment system may be coupled to one or more components of the engine system, such as the engine and/or a turbocharger. The implementations herein further include methods for assembling the engine system.

Additional implementations herein are directed to an engine system that includes the aftertreatment system described above. The engine system may include an internal combustion engine, such as a diesel engine, a gasoline engine, a propane engine, etc. or a hybrid engine (e.g., an engine that includes an internal combustion engine and an electric motor). The engine may include a combustion chamber that includes one or more cylinders. The combustion chamber may include a cylinder head that defines a top portion of the combustion chamber. In an example embodiment, the aftertreatment system is coupled to the engine. More specifically, the aftertreatment system is coupled to the cylinder head. The aftertreatment system may be structured to receive the exhaust gas from the engine. In some embodiments, the engine system may include a turbocharger. The aftertreatment system may be structured to receive the exhaust gas from the turbocharger.

### II. Overview of Example Engine Systems

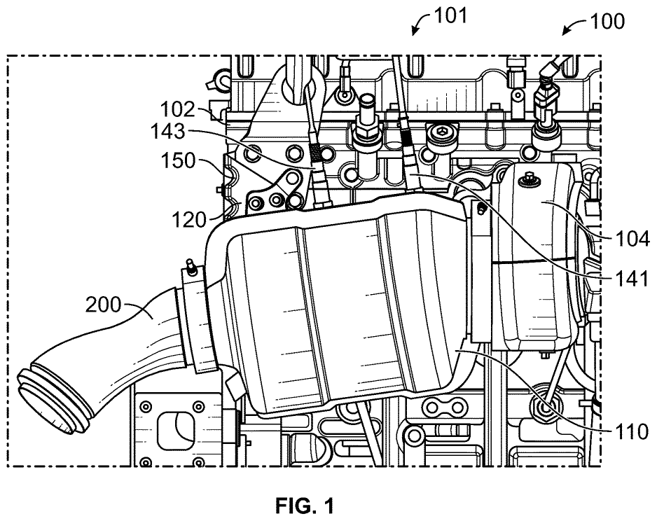

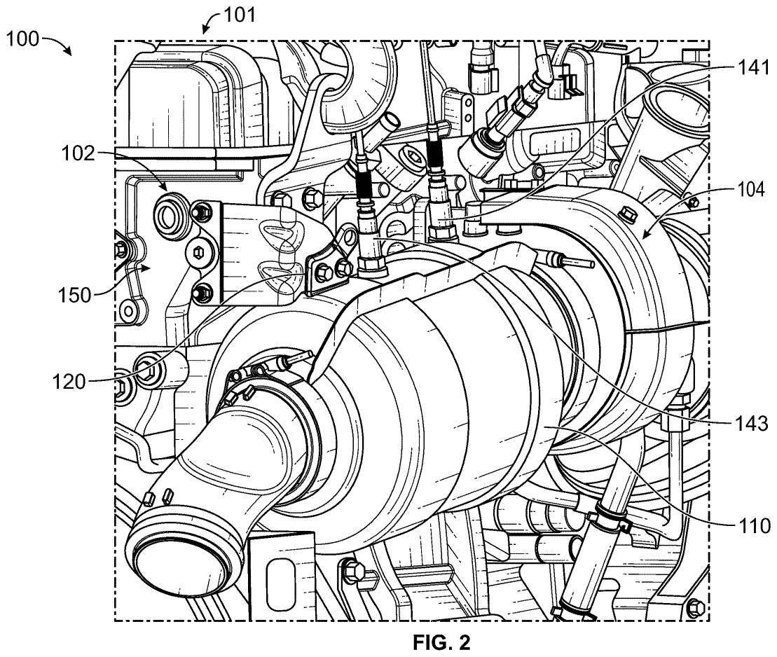

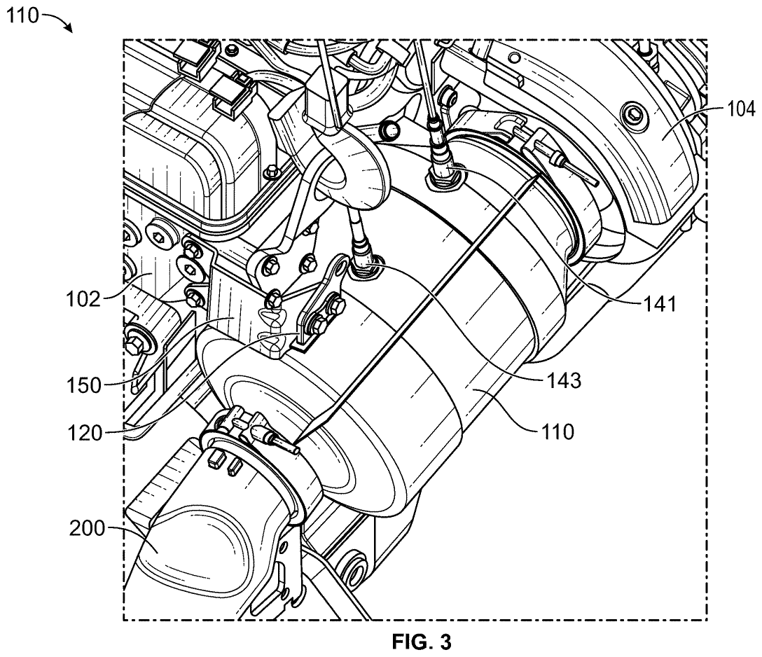

FIGS. 1-3 depict an engine system 100 (e.g., for a vehicle, a generator, work equipment, etc.) including an internal combustion engine 101 and an aftertreatment system 110 (e.g., treatment system, etc.). The internal combustion engine (ICE) 101 may be a diesel internal combustion engine, gasoline internal combustion engine, propane internal combustion engine, dual-fuel internal combustion engine, etc. In some embodiments, the ICE 101 may be part of a hybrid engine system that includes the ICE 101 and an electric motor. In an example embodiment, the ICE 101 is a gasoline internal combustion engine. The ICE 101 may include a cylinder head 102. In some embodiments, and as shown in FIGS. 1-3, the engine system 100 includes a turbocharger 104.

The aftertreatment system 110 is configured to treat exhaust produced by the internal combustion engine 101. Accordingly, the aftertreatment system 110 may be in fluid receiving communication with the ICE 101. In some embodiments, when the engine system 100 includes the turbocharger 104, the aftertreatment system 110 is in fluid receiving communication with the turbocharger 104. In some embodiments, the aftertreatment system 110 may be directly coupled to the turbocharger 104. The aftertreatment system 110 is configured to facilitate treatment of the exhaust. The treatment may facilitate reduction of emission of undesirable components (e.g., nitrogen oxides (NOx), sulfur oxide (SOx), etc.) in the exhaust. The treatment may also or instead facilitate conversion of various oxidation components (e.g., carbon monoxide (CO), hydrocarbons, etc.) of the exhaust into other components (e.g., carbon dioxide (CO₂), water vapor, etc.). The treatment may also or instead facilitate removal of particulates (e.g., soot, particulate matter, etc.) from the exhaust.

The aftertreatment system 110 includes an exhaust conduit system (e.g., line system, pipe system, etc.). The exhaust conduit system is configured to facilitate routing of the exhaust produced by the internal combustion engine 101 throughout the aftertreatment system 110 and to a downstream component and/or to atmosphere (e.g., ambient environment, etc.).

The aftertreatment system 110 may include one or more sensors. For example, in the example system of FIG. 1, the aftertreatment system 110 includes a first sensor 141 and a second sensor 143. The first sensor 141 and/or the second sensor 143 may be coupled to the exhaust aftertreatment system 110. The first sensor 141 and/or the second sensor 143 may be configured to detect information or data regarding operation of the exhaust aftertreatment system 110. The first sensor 141 and/or the second sensor 143 may monitor the characteristics (e.g., contents, temperature, pressure, etc.) of the exhaust within the exhaust aftertreatment system 110. The first sensor 141 and/or the second sensor 143 may also monitor characteristics of various components (e.g., a catalytic converter, a filter, etc.) of the exhaust aftertreatment system 110. For example, the exhaust aftertreatment system 110 may include one or more temperature sensors configured to detect a temperature at a location within the exhaust aftertreatment system 110.

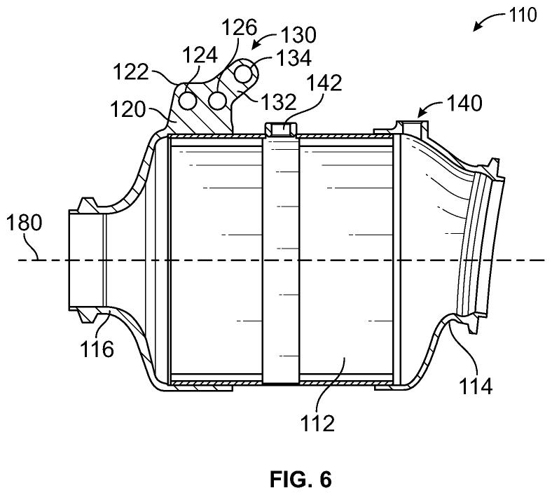

The aftertreatment system 110 may include a mounting bracket 120. As described in more detail herein with respect to FIGS. 4-6, the mounting bracket may be configured to couple to a connecting bracket 150. The connecting bracket 150 may be configured to couple to one or more components of the engine system 100. For example, and as shown in FIGS. 1-3, the connecting bracket 150 may be coupled to the ICE 101. More specifically, the connecting bracket 150 may be coupled to the cylinder head 102. Thus, the connecting bracket 150 is configured to enable coupling of the aftertreatment system 110 to the ICE 101 (or a component thereof, such as the cylinder head 102).

The exhaust may be routed to an exhaust pipe 200. In some embodiments, the exhaust pipe 200 may be in fluid providing communication with a downstream component, such as an underfloor aftertreatment system having an underfloor catalyst (not shown). In some embodiments, the exhaust pipe 200 may be configured to route the exhaust to the atmosphere.

FIGS. 4-6 depict the aftertreatment system 110. The aftertreatment system 110 includes a catalyst housing 112, a first endcap 114, and a shell 116 that includes a second endcap 118, and the mounting bracket 120. In some embodiments, and as shown in FIG. 4, the aftertreatment system 110 also includes a cover 160 disposed around the catalyst housing 112, the first endcap 114, and the shell 116.

The catalyst housing 112 may be substantially cylindrical in shape such that the catalyst housing 112 defines a central axis 180. The catalyst housing 112 is configured to contain one or more catalyst members. In an example embodiment, the catalyst housing 112 contains two catalyst members. The catalyst housing 112 may contain additional and/or alternative components such as a filter, etc. In some embodiments, the catalyst housing 112 includes one or more openings for receiving one or more sensors, such as the first sensor 141 and/or the second sensor 143. For example, the catalyst housing 112 may include a first sensor port 140 and a second sensor port 142. The first sensor port 140 may be configured to receive the first sensor 141, and the second sensor port 142 may be configured to receive the second sensor 143. In some embodiments, the first sensor port 140 and/or the second sensor port 142 are radially aligned with the mounting bracket 120. It should be understood that the catalyst housing 112 may include more or fewer sensor ports depending on the number of sensors desired to be included with the aftertreatment system 110.

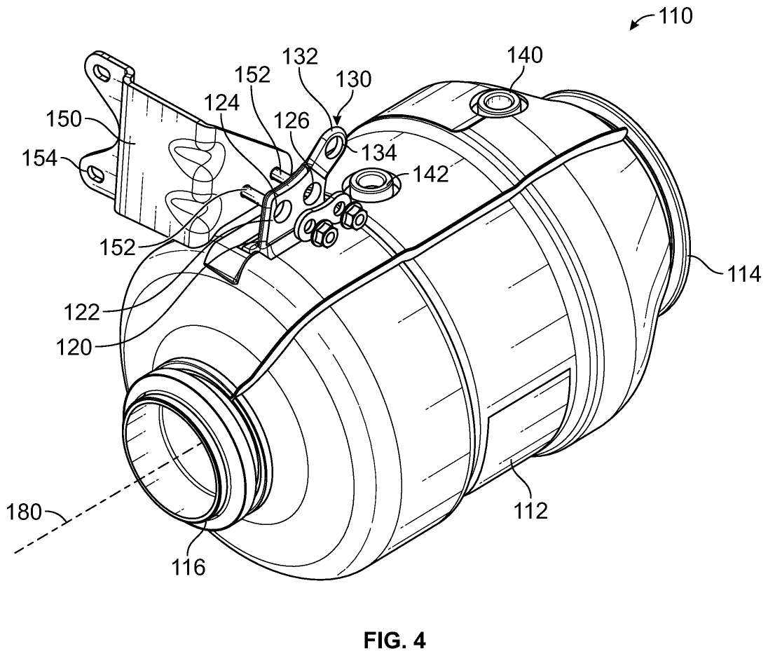

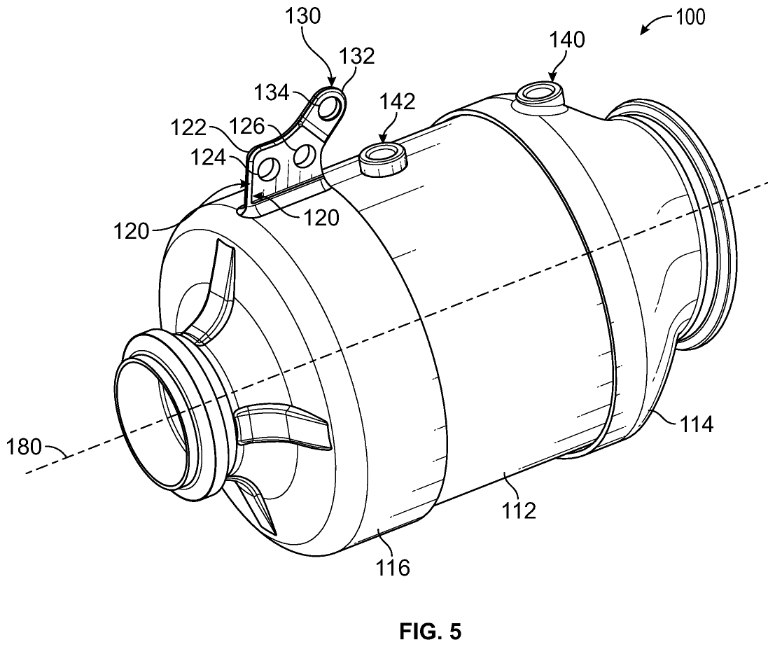

As shown in FIG. 5, the first endcap 114 may be disposed at the first end of the catalyst housing 112. In an example embodiment, the first endcap 114 is fixed to the catalyst housing 112 (e.g., by a welding process, an over-molding process, an additive manufacturing process, or other manufacturing processes). In some embodiments, the first endcap 114 may include a first opening for the sensor port 140.

The shell 116 may be disposed at a second end of the catalyst housing 112. As briefly described above, the shell 116 includes the second endcap 118 and the mounting bracket 120. In some embodiments, the second endcap 118 is monolithically formed with the mounting bracket 120. The shell 116 may be formed by a casting process where the second endcap 118 and the mounting bracket 120 are formed in by the casting process. In some embodiments, the shell 116 may be formed by a different manufacturing processes such as an additive manufacturing process. The second endcap 118 may be fixed to the catalyst housing 112 (e.g., by a welding process, an over-molding process, an additive manufacturing process, or other manufacturing processes).

The mounting bracket 120 includes a mounting portion 122 and a lift portion 130. The mounting bracket 120 is disposed at a first radial side of the shell 116 such that the mounting bracket 120 is radially aligned with the first sensor port 140 and/or the second sensor port 142.

As shown in FIGS. 4-6, the mounting portion 122 defines a first mounting opening 124 and a second mounting opening 126. The first mounting opening 124 and the second mounting opening 126 are configured to receive a fastener (e.g., bolt, screw, etc.) shown as a fasteners 152. The fasteners 152 are configured to couple the mounting bracket 120 to the connecting bracket 150.

The lift portion 130 extends axially and radially away from the mounting portion 122. The lift portion 130 extends radially away from the second endcap 118 and axially towards the first sensor port 140 and/or the second sensor port 142 such that a gap is defined between the catalyst housing 112 and the lift portion 130. In some embodiments, the lift portion includes a ring portion 132 that defines a lift opening 134. The lift opening 134 is configured to receive a portion of a lift arm such that the lift arm is operable to lift the aftertreatment system 110 by engaging the ring portion 132. In some embodiments, the lift portion 130 is axially and radially aligned with a center of gravity of the aftertreatment system 110.

The connecting bracket 150 is configured to couple the aftertreatment system 110 to the ICE 101. In some embodiments, the connecting bracket 150 is coupled to the mounting bracket 120 by one or more fasteners 152. The connecting bracket 150 may be coupled to the ICE 101, or a component thereof, such as the cylinder head 102.

The cover 160 is disposed around at least a portion of the catalyst housing 112, the first endcap 114, and/or the shell 116 such that the catalyst housing 112, the first endcap, and the shell 116 are at least partially contained within the cover 160. The cover 160 may be a thermal cover configured to at least partially thermally insulate an interior of the aftertreatment system 110 from an exterior of the aftertreatment system 110. For example, the cover 160 may mitigate heat from transferring radially through the catalyst housing 112, the first endcap, and/or the shell 116.

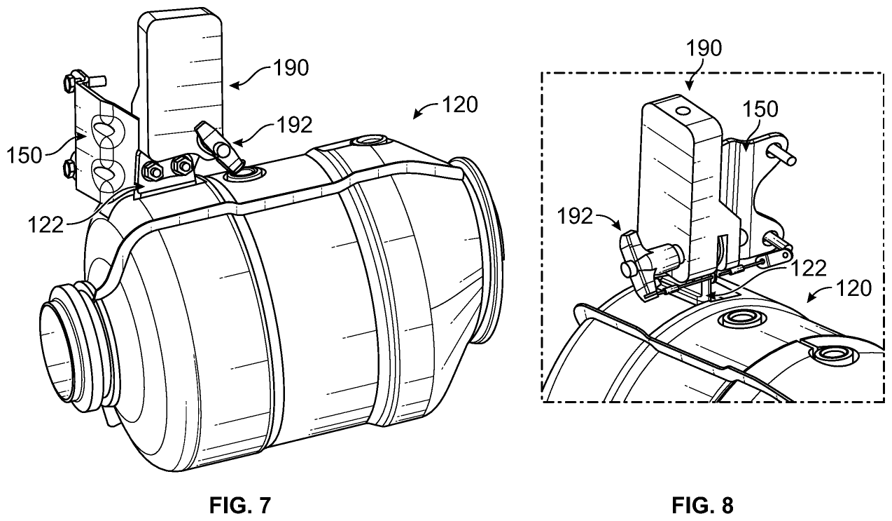

Now referring to FIGS. 7 and 8 the aftertreatment system 110 is shown with the lifting arm 190, according to an example embodiment. As briefly described above, a portion 191 of the lift arm 190 is received by the lift opening 134. The portion 191 of the lift arm 190 engages with the lift ring 132 to lift the aftertreatment system 110.

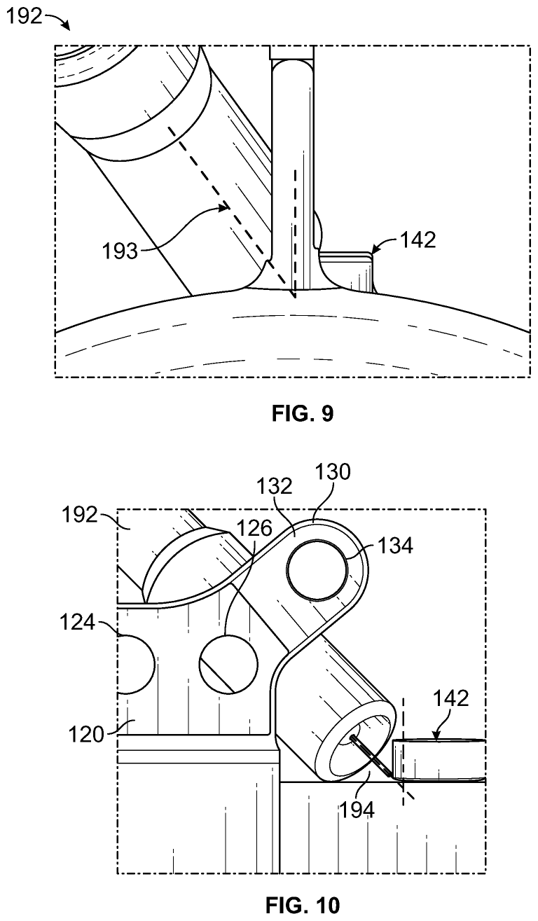

Now referring to FIGS. 9 and 10, an example manufacturing process is shown, according to an example embodiment. As shown, a manufacturing tool shown as a welding device 192 may be used in the manufacturing process. The manufacturing process may include coupling (e.g., welding by the welding device 192) the sensor port 142 to the catalyst housing 112. The sensor port 142 is structured to receive a sensor, such as the sensor 143. For example, the sensor port 142 may include internal threads for threadably coupling to the sensor 143. The lift portion 130 is disposed radially away from the catalyst housing 112 such that the gap defined between the catalyst housing 112 and the lift portion 130 is large enough to receive at least a portion of the welding device 192 therein, when the welding device 192 used to weld the sensor port 142 to the catalyst housing 112. More specifically, the welding device 192 is provided, at least partially in the gap defined between the catalyst housing 112 and the lift portion 130 such that a first angle 193 is defined between the mounting bracket 120 and the welding device 192 and a second angle 194 is defined between the sensor port 142 and the welding device 192. The first angle 193 may be between 25° and 30°, or, more specifically, 27°. The second angle may be between 35° and 40°, or, more specifically, 39°.

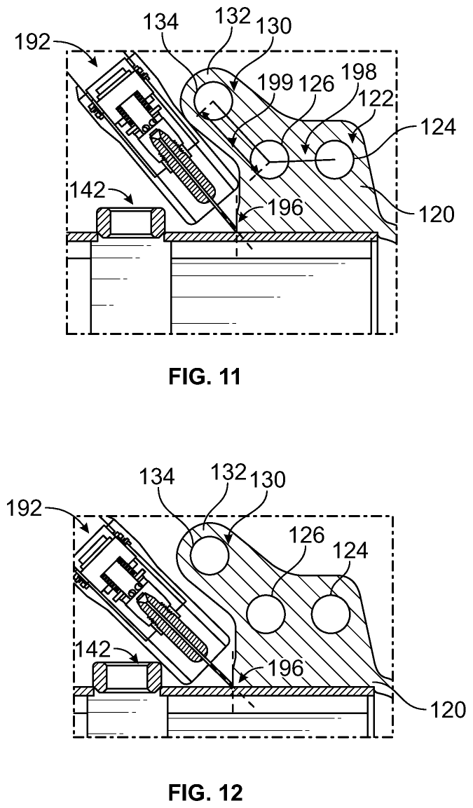

Now referring to FIGS. 11 and 12, a manufacturing process is shown, according to an example embodiment. As shown, a manufacturing tool shown as the welding device 192 may be used in a manufacturing process. A method of assembling the exhaust aftertreatment system 110 may include the manufacturing process. The method may include providing the catalyst housing 112. In some embodiments, the catalyst housing contains one or more catalysts therein. The method includes coupling the first endcap 114 to a first end of the catalyst housing 112. The method also includes providing the shell 116 to a second end of the catalyst housing.

In some embodiments a method may include providing the ICE 101, providing the exhaust aftertreatment system 110, engaging, by the portion 191 of a lift arm 190, the lift opening 134 such that the portion 191 of the lift arm 190 is received by the lift opening 134, lifting the exhaust aftertreatment system 110, by the portion 191 of the lift arm 190 received by the lift opening 134, and coupling the exhaust aftertreatment system 110 to the ICE 101 (or a component thereof, such as the cylinder head 102) by the connecting bracket 150. The method may also include disengaging, by the portion 191 of the lift arm 190, the lift opening 134. The method may also include coupling the exhaust aftertreatment system 110 to the turbocharger 104 such that the exhaust aftertreatment system 110 is directly coupled to the turbocharger 104.

Coupling the shell 116 to the catalyst housing 112 may include welding (e.g., by using the welding device 192) the shell 116 to the catalyst housing 112. The lift portion 130 is disposed radially away from the catalyst housing 112 such that the gap defined between the catalyst housing 112 and the lift portion 130 is large enough to receive at least a portion of the welding device 192 when the welding device 192 used to weld the shell 116 to the catalyst housing 112. More specifically, the welding device 192 is provided at least partially in the gap defined between the catalyst housing 112 and the lift portion 130, such that a third angle 196 is defined between the mounting bracket 120 and the welding device 192. As shown in FIGS. 11 and 12, the third angle 196 may be between 35° and 45°, or, more specifically between 40° and 45°. As shown in FIG. 11, at the maximum value of the third angle 196, at least a portion of the welding device 192 contacts the mounting bracket. As shown in FIG. 12, at the minimum value of the third angle 196, at least a portion of the welding device 192 contacts the sensor port 142.

As shown in FIG. 11, an angle 198 defined between the mounting opening 126 and the lift opening 134 is between 35° and 45°, or, more specifically, 40°. More specifically, the angle is defined between a first line, defined from a center of the first mounting opening 124 to a center of the second mounting opening 126, and a second line, defined between the center of the second mounting opening 126 and the lift opening 134. A distance between the mounting opening 126 and the lift opening 134 is between 25 millimeters (mm) and 40 mm, or, more specifically, 31.25 mm. More specifically, the distance is defined between the center of the second mounting opening 126 and the center of the lift opening 134.

### III. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, reductant, an air-reductant mixture, exhaust, may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

1. An exhaust aftertreatment assembly comprising:
a catalyst housing configured to contain at least one catalyst therein, the catalyst housing comprising a first sensor port defined through an outer wall of the catalyst housing; and
a shell coupled to the catalyst housing, the shell comprising:
an end cap fixed to the catalyst housing, and
a mounting bracket monolithically formed with the end cap and extending radially away from the end cap such that the mounting bracket is radially aligned with the first sensor port, the mounting bracket comprising:
a mounting portion, the mounting portion defining a first mounting opening structured to receive a first fastener, and
a lift portion extending away from the mounting portion, the lift portion defining a lift opening structured to receive a portion of a lifting arm.

2. The exhaust aftertreatment assembly of claim 1, further comprising the at least one catalyst contained in the catalyst housing.

3. The exhaust aftertreatment assembly of claim 2, the lift portion extends axially and radially away from the mounting portion, and wherein an angle between the first mounting opening and the lift opening is between 35° and 40° and a distance between the first mounting opening and the lift opening is between 25 millimeters (mm) and 40 mm.

4. The exhaust aftertreatment assembly of claim 1, wherein the mounting portion defines a second mounting opening, the second mounting opening structured to receive a second fastener.

5. The exhaust aftertreatment assembly of claim 1, wherein the exhaust aftertreatment assembly is directly coupled to a turbocharger of a gasoline engine such that the exhaust aftertreatment assembly is in fluid receiving communication with the turbocharger.

6. The exhaust aftertreatment assembly of claim 1, wherein the mounting bracket is positioned at a first radial end of the end cap such that the lift portion is axially aligned with a center of gravity of the exhaust aftertreatment assembly.

7. (canceled)

8. The exhaust aftertreatment assembly of claim 1, wherein the first sensor port is structured to receive a first sensor.

9. The exhaust aftertreatment assembly of claim 1, wherein the first sensor port is disposed axially away from the mounting bracket.

10. The exhaust aftertreatment assembly of claim 9, wherein the lift portion extends axially towards the first sensor port and radially away from the end cap such that a gap is defined between the lift portion and the first sensor port.

11. A gasoline engine system comprising:
an engine;
a connecting bracket coupled to the engine; and
an exhaust aftertreatment system coupled to the connecting bracket, the exhaust aftertreatment system comprising:
a catalyst housing configured to contain at least one catalyst therein, the catalyst housing comprising a first sensor port defined through an outer wall of the catalyst housing, and
a shell coupled to the catalyst housing, the shell comprising:
an end cap fixed to the catalyst housing, and
a mounting bracket monolithically formed with the end cap and extending radially away from the end cap such that the mounting bracket is radially aligned with the first sensor port, the mounting bracket comprising:
a mounting portion, the mounting portion defining a first mounting opening structured to receive a first fastener such that the first fastener couples the shell to the connecting bracket, and
a lift portion extending away from the mounting portion, the lift portion defining a lift opening structured to receive a portion of a lifting arm.

12. The gasoline engine system of claim 11, wherein the mounting portion defines a second mounting opening, the second mounting opening structured to receive a second fastener such that the second fastener couples the shell to the connecting bracket.

13. The gasoline engine of claim 11, wherein an angle between the first mounting opening and the lift opening is between 35° and 40° and a distance between the first mounting opening and the lift opening is between 25 millimeters (mm) and 40 mm.

14. The gasoline engine of claim 11, wherein:
the first sensor port is structured to receive a first sensor, and disposed axially away from the mounting bracket, and
the lift portion extends axially towards the first sensor port and radially away from the end cap such that a gap is defined between the lift portion and the first sensor port.

15. The gasoline engine of claim 11, further comprising a turbocharger, wherein the exhaust aftertreatment system is directly coupled to the turbocharger such that the exhaust aftertreatment system is in fluid receiving communication with the turbocharger.

16. The gasoline engine of claim 11, wherein the engine comprises a cylinder head, and the connecting bracket is coupled to the cylinder head.

17. A method of assembling an engine system, the method comprising:
providing an engine;
providing an exhaust aftertreatment system comprising:
a catalyst housing configured to contain at least one catalyst therein, the catalyst housing comprising a first sensor port defined through an outer wall of the catalyst housing; and
a shell coupled to the catalyst housing, the shell comprising:
an end cap fixed to the catalyst housing, and
a mounting bracket monolithically formed with the end cap and extending radially away from the end cap such that the mounting bracket is radially aligned with the first sensor port, the mounting bracket comprising:
a mounting portion, the mounting portion defining a first mounting opening structured to receive a first fastener, and
a lift portion extending away from the mounting portion, the lift portion defining a lift opening;
engaging, by a portion of a lift arm, the lift opening such that the portion of the lift arm is received by the lift opening;
lifting the exhaust aftertreatment system, by the portion of the lift arm received by the lift opening; and
coupling the exhaust aftertreatment system to the engine by a connecting bracket structured to receive the first fastener.

18. The method of claim 17, further comprising disengaging, by the portion of the lift arm, the lift opening.

19. The method of claim 17, wherein an angle between the first mounting opening and the lift opening is between 35° and 40° and a distance between the first mounting opening and the lift opening is between 25 millimeters (mm) and 40 mm.

20. The method of claim 17, further comprising coupling the exhaust aftertreatment system to a turbocharger such that the exhaust aftertreatment system is directly coupled to the turbocharger.
